(19) United States
(12) Patent Application Publication
(10) Pub. No.: US 2012/0112490 A1
(43) Pub. Date: May 10, 2012

(54) MIRROR UNIT, AND SUN VISOR BODY HAVING MIRROR UNIT

(75) Inventor: Tsuyoshi FUKATSU, Toyota-shi (JP)

(73) Assignee: KYOWA SANGYO CO., LTD., Toyota-shi (JP)

(21) Appl. No.: 13/292,443

(22) Filed: Nov. 9, 2011

(30) Foreign Application Priority Data
Nov. 9, 2010 (JP) 2010-250501

(51) Int. Cl. B60J 3/00; F21V 33/00

(52) U.S. Cl. 296/97.1; 362/142; 296/97.5

(57) ABSTRACT

A mirror unit includes: a frame; a mirror that is mounted on the frame; a cover that is mounted on the frame and that covers the mirror; two facing wall portions that extend along the frame; and guide members that are respectively formed on both wall portions, that protrude in a direction in which both wall portions face each other and that allow the cover to slide along the frame. A guide member-absent region in which the guide member is partially not formed is provided at an end portion of at least one of the wall portions.

### INCORPORATION BY REFERENCE

The disclosure of Japanese Patent Application No. 2010-250501 filed on Nov. 9, 2010 including the specification, drawings and abstract is incorporated herein by reference in its entirety.

### BACKGROUND OF THE INVENTION

1. Field of the Invention

The invention relates to a mirror unit that is mounted on a sun visor body and also relates to a sun visor body having the mirror unit.

2. Description of Related Art

Japanese Patent Application Publication No. 2004-237911 (JP-A-2004-237911) describes a mirror unit that is mounted on a sun visor body of a vehicle sun visor. The mirror unit described in JP-A-2004-237911 is formed of a rectangular frame, a mirror that is mounted on the frame and a cover that slides between a mirror covered position in which the mirror is covered and a mirror exposed position in which the mirror is exposed. In the thus configured mirror unit, slide protrusions provided on both end surfaces of the cover are respectively fitted in the guide grooves of rails formed on a pair of facing side wall portions of the frame to thereby slidably mount the cover on the frame.

### SUMMARY OF THE INVENTION

With the thus configured mirror unit, the distance from one of the slide protrusion end surfaces of the cover to the other one of the slide protrusion end surfaces is set so as to be substantially equal to the distance from the guide groove bottom of one of the rails to the guide groove bottom of the other one of the rails. Therefore, the cover is mounted on the frame in such a manner that the slide protrusions of the cover are fitted into the guide grooves of the rails while deforming the pair of side wall portions of the frame so as to widen the space between the side wall portions (increase the distance between the grooves). Therefore, the frame may be deformed to be expanded and, as a result, there is a possibility that a predetermined slide load for sliding the cover cannot be obtained or a rattle of the cover occurs, so there is still room for improvement in terms of this point.

The invention provides a mirror unit that is improved in mountability of a cover on a frame, and also provides a sun visor body having the mirror unit.

A first aspect of the invention provides a mirror unit. The mirror unit includes: a frame that is fixed to a sun visor body; a mirror that is mounted on the frame; and a cover that is mounted on the frame and that covers the mirror. The mirror unit further includes: two facing wall portions that are formed on the frame and that extend along the frame; and guide members that are respectively formed on both wall portions, that protrude in a direction in which both wall portions face each other and that allow the cover to slide along the wall portions. One end of each of the guide members is open, and a guide member-absent region in which the guide member is partially not formed is provided at an end portion of at least one of both wall portions. The end portion of the wall portion is adjacent to the one end of the guide member.

With the mirror unit according to the first aspect of the invention, the guide member-absent region is provided at the end portion of at least one of both wall portions. Then, in the guide member-absent region, the cover is placed at the end portions of the wall portions along a direction perpendicular to a plane formed by the frame, and the guide members allow the cover to slide into a space surrounded by the frame to be accommodated while guiding the cover. That is, the cover is placed at the end portions of the wall portions using the guide member-absent region, and then the cover is slid along the wall portions while guiding the cover with the guide members to thereby make it possible to accommodate the cover in the space surrounded by the frame. Therefore, the cover may be easily mounted on the frame without deforming the frame. As a result, it is effective to stabilize a slide load of the mounted mirror and avoid a rattle of the mirror.

A guide member-present region in which the guide member is formed may be provided at the end portion of one of both wall portions, and the guide member-absent region may be provided at the end portion of the other one of both wall portions. One end of the cover serves as a pivot center at or near the wall portion having the guide member-present region, and the other end of the cover is placed at the wall portion having the guide member-absent region by pivoting the cover. By so doing, the cover is placed at one end portions of both wall portions. That is, the cover is placed on the wall portions along a direction perpendicular to a plane formed by the frame.

According to the above aspect, in a state where the cover is inclined with respect to the direction along the plane formed by the frame and one end of the cover is pressed against the wall portion having the guide member-present region or a portion near that wall portion, the cover is pivoted so as to be parallel to the plane formed by the frame to thereby make it possible to easily place the cover at the one end portions of the wall portions of the frame.

A second aspect of the invention provides a vehicle sun visor. The vehicle sun visor includes: the mirror unit according to the first aspect; and a sun visor body that has an accommodating portion for accommodating the mirror unit. By so doing, it is possible to provide the vehicle sun visor having the mirror unit that allows the cover to be easily mounted on the frame and that is effective to stabilize a slide load of the mounted mirror and avoid a rattle of the mirror.

According to the above aspects, the mirror unit that is improved in mountability of the cover on the frame and the sun visor body having the mirror unit are provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view that shows the configuration of a vehicle sun visor that includes a mirror unit according to an embodiment of the invention;

FIG. 2 is an exploded perspective view that shows components of the mirror unit;

FIG. 3A to FIG. 3D are views that show processes of assembling the mirror unit;

FIG. 4 is a top view of the assembled mirror unit when viewed from the front surface side of the mirror unit;

FIG. 5 is a bottom view of the mirror unit in which a slide cover is assembled to a frame when viewed from the back surface side of the mirror unit;

FIG. 6 is a cross-sectional view taken along the line VI-VI in FIG. 4;

FIG. 7A to FIG. 7C are cross-sectional views taken along the line VII-VII in FIG. 4 in the processes in which the slide cover is assembled to the frame;

FIG. 8A is a cross-sectional view that shows the structure before the mirror unit is assembled to a sun visor body;

FIG. 8B is a cross-sectional view that shows the structure after the mirror unit is assembled to the sun visor body; and

FIG. 9 is a cross-sectional view that shows the structure, at a portion different from that of FIG. 8B, by which the mirror unit is assembled to the sun visor body.

### DETAILED DESCRIPTION OF EMBODIMENTS

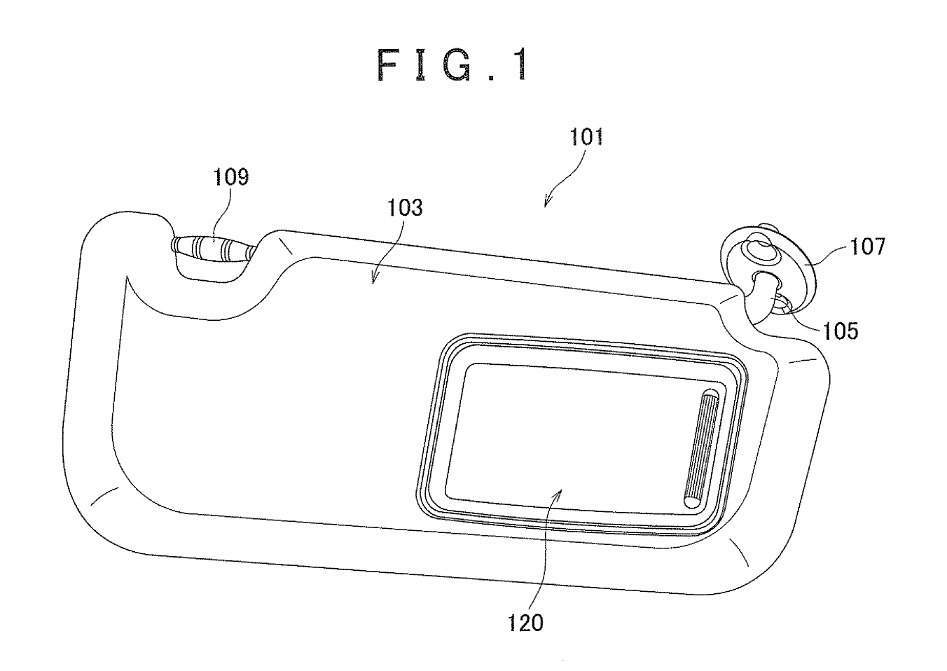

Hereinafter, a mirror unit according to an embodiment of the invention will be described with reference to FIG. 1 to FIG. 9. The mirror unit according to the present embodiment is used with being assembled to a vehicle sun visor. As shown in FIG. 1, the vehicle sun visor 101 is generally formed of a substantially rectangular sun visor body 103 and a support shaft 105. The sun visor body 103 forms the outline shape of the sun visor 101. The support shaft 105 is used to mount the sun visor body 103 on a vehicle. The support shaft 105 is formed in a substantially L shape, and has a vertical shaft portion that extends in a substantially vertical direction and a horizontal shaft portion that extends in a substantially horizontal direction. The horizontal shaft portion of the support shaft 105 is assembled to a bearing portion (not shown for the sake of convenience) incorporated at one of the corners of the upper edge portion of the sun visor body 103. By so doing, the sun visor body 103 is relatively pivotable about the axis of the horizontal shaft portion. The vertical shaft portion of the support shaft 105 is pivotably mounted at the front-side corner portion of a ceiling surface (not shown for the sake of convenience) of a vehicle cabin via a mounting bracket 107 so that the longitudinal direction of the sun visor body 103 is oriented in the widthwise direction of the vehicle.

The sun visor 101 mounted on the ceiling surface of the vehicle cabin pivots about the axis of the horizontal shaft portion to make it possible to change the position between a storage position in which the sun visor 101 is placed so as to face the ceiling surface of the vehicle cabin and a shading position in which the sun visor 101 is placed so as to face a windshield. In addition, the sun visor 101 pivots about the vertical shaft portion to make it possible to change the position between a front position in which the sun visor 101 faces the windshield and a side position in which the sun visor 101 faces a side window glass. In addition, the sun visor body 103 has a support shaft 109 at a free end side of the upper edge portion. The support shaft 109 is detachably anchored by a hook (not shown for the sake of convenience) fastened to the ceiling surface of the vehicle cabin. By so doing, when the position of the sun visor 101 is changed from the storage position to the shading position or from the shading position to the storage position, the sun visor body 103 stably pivots.

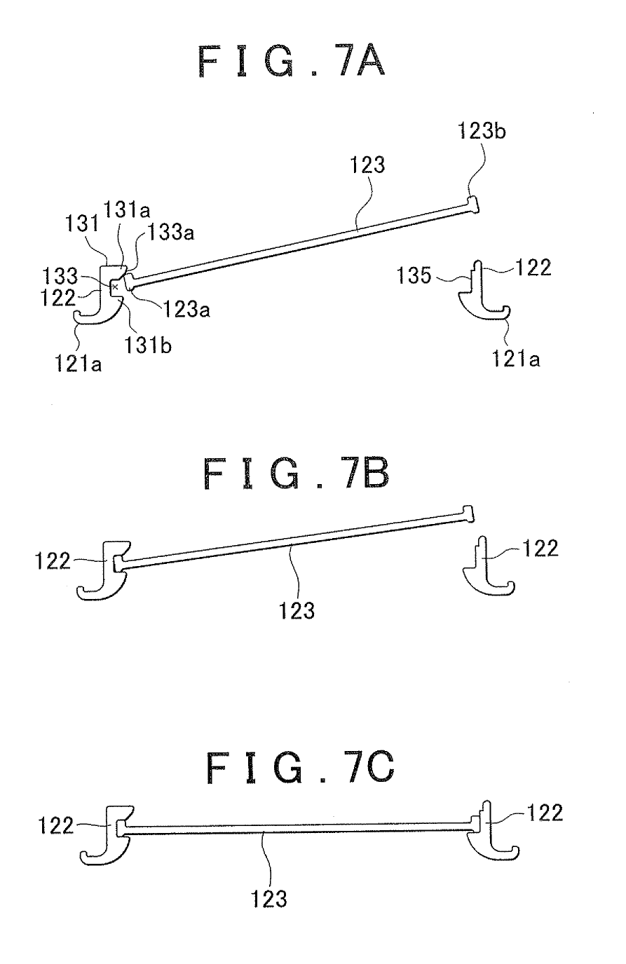

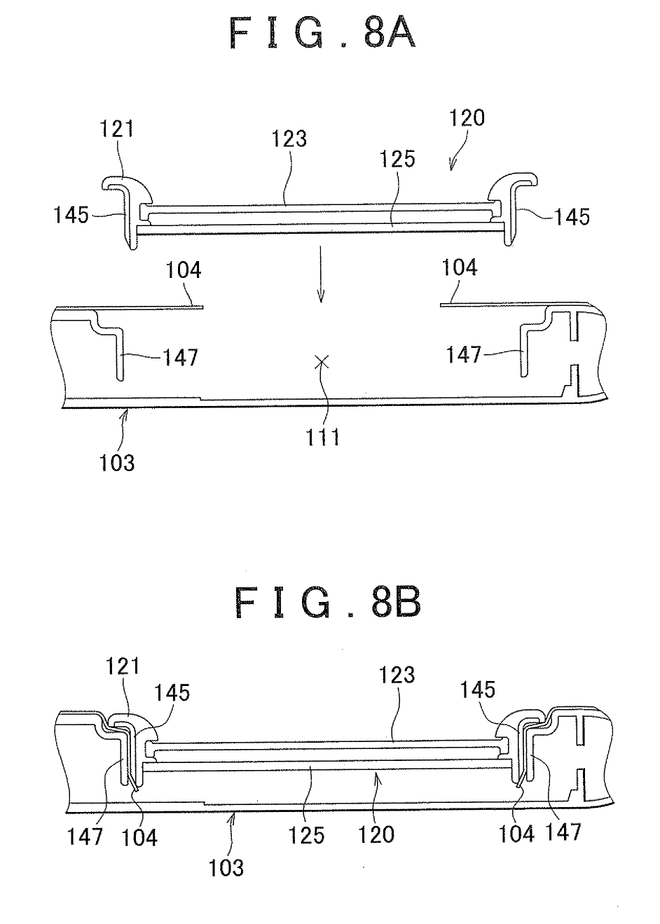

A substantially rectangular mirror unit accommodating recess 111 (see FIG. 8A) is formed on the front surface side (surface facing a passenger in the shading position of the sun visor 101) of the sun visor body 103. The mirror unit accommodating recess 111 is long in the direction along the horizontal shaft of the support shaft 105, and is used to Mount the mirror unit 120. The mirror unit 120 is fitted into the mirror unit accommodating recess 111 from the front surface side.

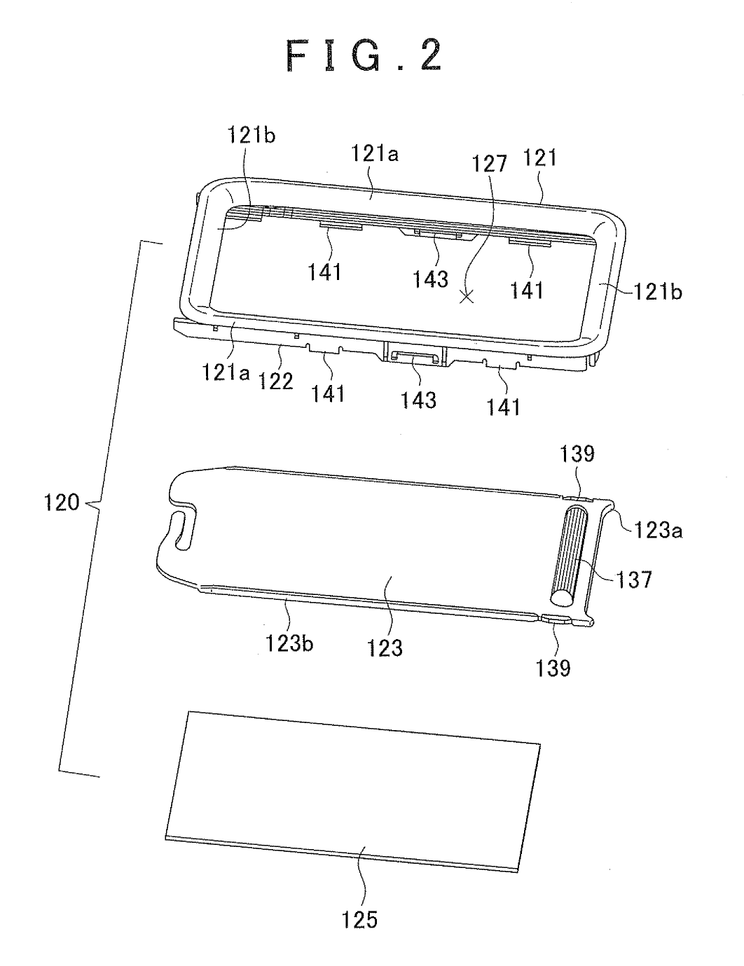

Next, the mirror unit 120 will be described with reference to FIG. 2 to FIG. 7C. As shown in FIG. 2, the mirror unit 120 is principally formed of a synthetic resin frame 121, a synthetic resin slide cover 123 and a mirror (plane mirror) 125. The frame 121 constitutes a unit body. The slide cover 123 is slidably mounted on the frame 121. The mirror 125 is fixed to the frame 121. The slide cover 123 functions as the “cover” according to the aspect of the invention.

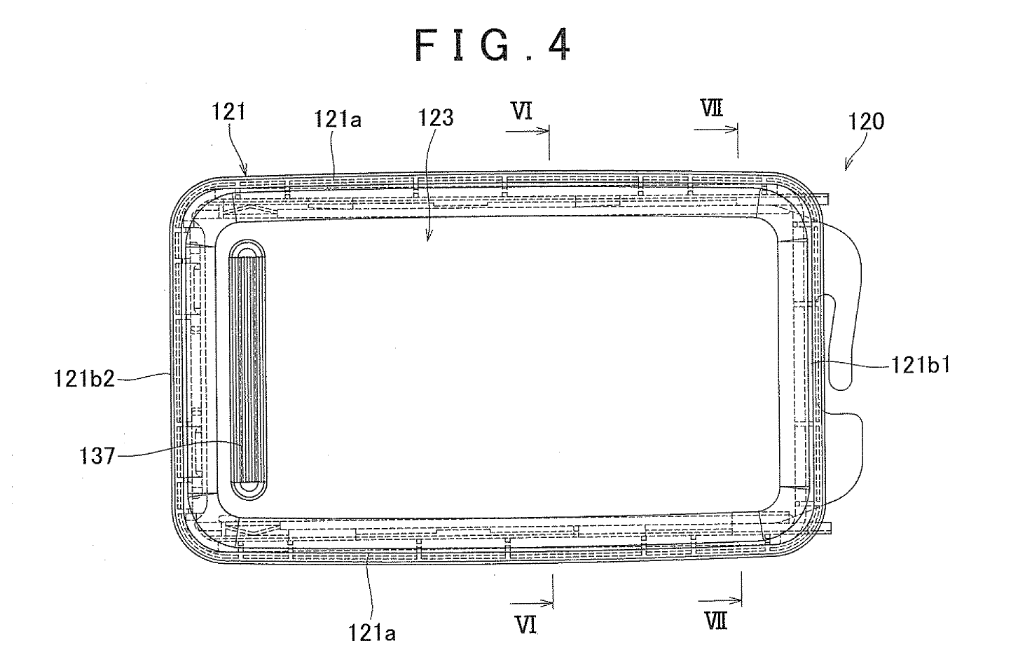

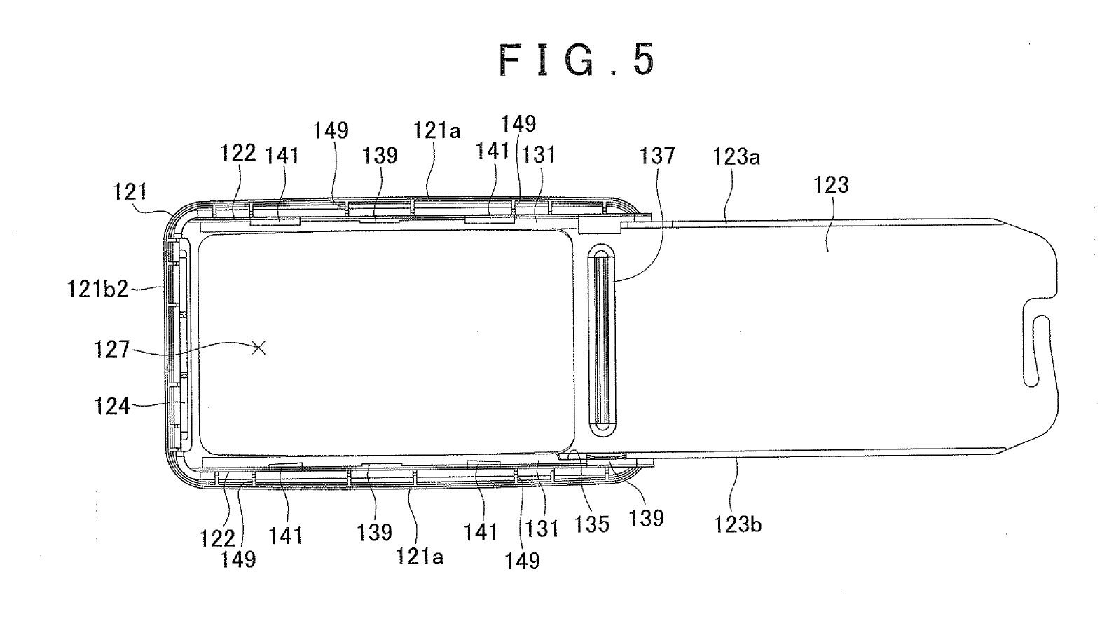

The frame 121 has a rectangular shape. The frame 121 has two horizontal frame portions 121a and vertical frame portions 121b. The horizontal frame portions 121a extend parallel to each other and form the long sides of the frame 121. The vertical frame portions 121a connect the respective horizontal frame portions 121a at the end portions of both horizontal frame portions 121a. Then, both horizontal frame portions 121a and both vertical frame portions 121b of the frame 121 define a rectangular open space 127. As shown in FIG. 5 and FIG. 6, mounting frame portions 122 for mounting the slide cover 123 and the mirror 125 are integrally formed on the back surface sides of both horizontal frame portions 121a over the entire length of each horizontal frame portion 121a. Each mounting frame portion 122 protrudes by a predetermined height from the back surface side of the corresponding horizontal frame portion 121a. The slide cover 123 is accommodated in the space between these mounting frame portions 122. The mounting frame portions 122 function as the “wall portions” according to the aspect of the invention. The surfaces of the horizontal frame portions 121a and vertical frame portions 121b also serve as decorative surfaces.

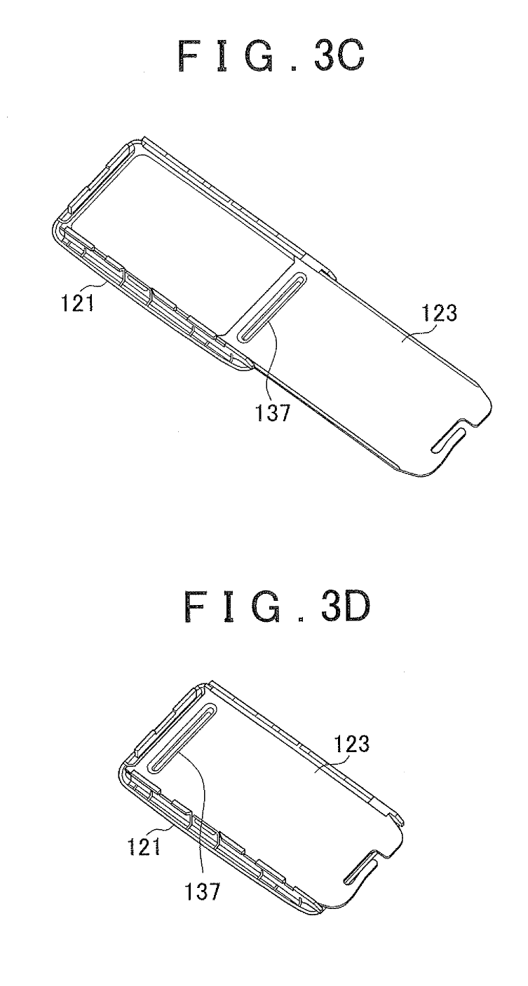

The slide cover 123 is mounted on the mounting frame portions 122 via guide rail portions 131 so as to be slidable in the direction in which the guide rail portions 131 extend. The guide rail portions 131 are respectively formed on the mounting frame portions 122. The mirror 125 is fixed to the mounting frame portions 122 on the back surface side of the slide cover 123. The slide cover 123 is a substantially rectangular plate. The slide cover 123 moves between an open position (indicated in FIG. 5) in which the open space 127 is open and a closed position (indicated in FIG. 4) in which the open space 127 is closed. When the slide cover 123 is moved to the open position, the mirror 125 is exposed to the front surface side through the open space 127. When the slide cover 123 is moved to the closed position, the mirror 125 is covered.

As shown in FIG. 6, the guide rail portions 131 are formed on the inner surfaces of both mounting frame portions 122 (facing surfaces of both mounting frame portions 122). The guide rail portions 131 guide sliding of the slide cover 123. The guide rail portions 131 function as the “guide members” according to the aspect of the invention. Both guide rail portions 131 respectively have guide grooves 133 each having a U-shaped cross section. Slide portions 123a and 123b of the slide cover 123 are respectively inserted in the guide grooves 133. Pairs of back surface side and front surface side rail portions 131a and 131b protrude inward (toward the cover accommodating space) substantially parallel to each other by a predetermined length to thereby restrict the slide cover 123 from slipping off in the widthwise direction (horizontal direction of FIG. 6) and thickness direction (vertical direction of FIG. 6) of the frame 121. The slide portions 123a and 123b of the slide cover 123 are protrusions respectively formed at the long side edge portions of the slide cover 123 over substantially the entire length of the long side edge portion, and are thicker than the slide cover 123.

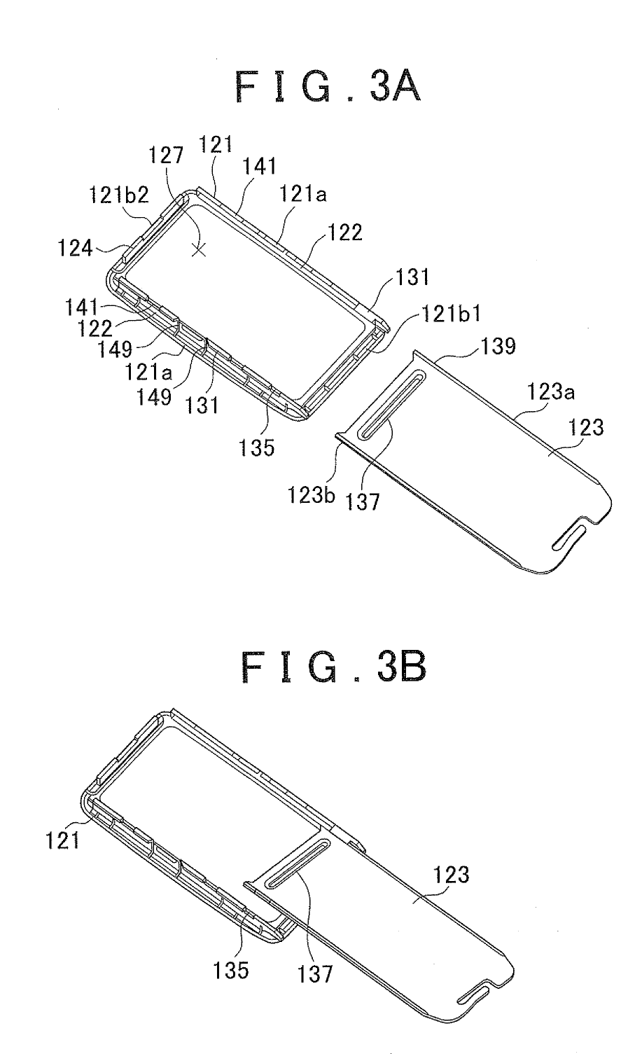

As shown in FIG. 3A to FIG. 3D, the slide cover 123 is mounted on the mounting frame portions 122 in such a manner that the slide portions 123a and 123b are inserted into the guide grooves 133 of the guide rail portions 131 from the side of the first vertical frame portion 121b1. Therefore, the back surface of the first vertical frame portion 121b1 from which the cover is inserted is formed so as to be flush with the front surface side rail portions 131b of the guide rail portions 131 in order to allow the slide cover 123 to be mounted and to allow the mounted slide cover 123 to move to the position in which the mirror 125 is exposed. That is, the back surface side of the first vertical frame portion 121b1 is an open space that allows the slide cover 123 to move between the closed position and the open position. In other words, no member is provided on the back surface side of the first vertical frame portion 121b1. Note that the distance between the cover 123 and the first vertical frame portion 121b1 may be equal to or longer than the distance between the cover 123 and the front surface side rail portions 131b (the surfaces of the guide rail portions 131, on which the cover 123 is arranged). A stopper 124 (see FIG. 3A) is formed on the back surface of the second vertical frame portion 121b2 provided at the opposite side of the first vertical frame portion 121b1. The slide cover 123 that is moved to the position in which the mirror 125 is covered contacts the stopper 124 to stop in the closed position.

In addition, in order to assemble the slide cover 123, the guide grooves 133 of the guide rail portions 131 are open at one end portions adjacent to the first vertical frame portion 121b1, and the slide portions 123a and 123b of the slide cover 123 are inserted from the one end portions.

A knob 137 is formed on the front surface of the slide cover 123 for opening or closing the cover. The knob 137 is formed of a protrusion that protrudes by a predetermined height from the surface of the cover at a portion adjacent to the distal end side in the direction in which the cover is inserted at the time of assembling the cover. The knob 137 extends in the direction perpendicular to the direction in which the slide cover 123 slides. Therefore, even when the slide cover 123 is attempted to be inserted from the one end portions of the guide grooves 133 along the back surface of the first vertical frame portion 121b1, the slide cover 123 cannot be inserted because of interference with the knob 137. That is, as shown in FIG. 3A, the slide cover 123 cannot be inserted into the guide grooves 133 from the outer side of the first vertical frame portion 121b1 in a state where the slide cover 123 is placed parallel to the frame 121.

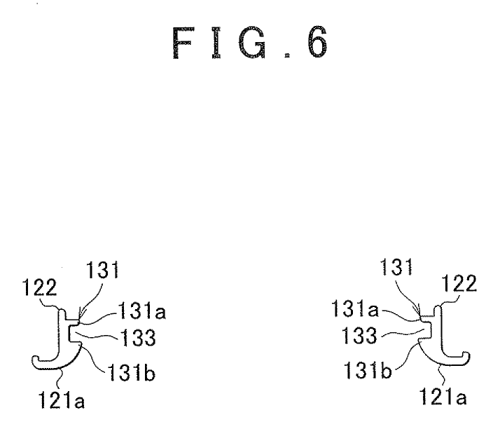

Then, in the present embodiment, in order to allow the slide cover 123 to be assembled to the frame 121 while avoiding interference of the knob 137 with the first vertical frame portion 121b1, the guide rail portion 131 of one of the mounting frame portions 122 is shorter than the guide rail portion 131 of the other one of the mounting frame portions 122. That is, as shown in FIG. 3A to FIG. 3D, FIG. 5, and FIG. 7A to FIG. 7C, one of the mounting frame portions 122 has the guide rail portion 131 that is formed over substantially the entire length of the mounting frame portion 122; whereas the other one of the mounting frame portions 122 has a region in which the guide groove 133 is not formed in a predetermined range adjacent to the cover insertion side, that is, a rail-absent region 135 in which the guide rail portion 131 that forms the guide groove 133, that is, the back surface side rail portion 131a, is partially absent. The rail-absent region 135 in which the back surface side rail portion 131a is absent functions as the “guide member-absent region” according to the aspect of the invention.

With the above configuration according to the present embodiment, the slide cover 123 may be easily mounted on the frame 121. That is, as shown in FIG. 3B and FIG. 7A to FIG. 7C, on the back surface side of the frame 121, the slide cover 123 is inclined obliquely with respect to the frame 121, and an inserting end portion (left side end portion in FIG. 3A to FIG. 3D and left end in FIG. 7A to FIG. 7C) of one slide portion 123a of the slide cover 123 is inserted into the guide groove 133 of the guide rail portion 131 of one of the mounting frame portions 122 (see FIG. 7B). After that, the slide cover 123 is pivoted downward in FIG. 7B about the wall surface of that guide groove 133, an inserting end portion of the other slide portion 123b of the slide cover 123 is arranged in the rail-absent region 135 of the other one of the mounting frame portions 122. That is, the slide cover 123 is placed along the direction perpendicular to the plane formed by the frame 121, and is arranged parallel to the mounting frame portions 122. This state is shown in FIG. 3C and FIG. 7C. At this time, the knob 137 of the slide cover 123 is arranged inside the open space 127 of the frame 121. In this state, when the slide cover 123 is moved toward the opposite side, the slide portions 123a and 123b of the slide cover 123 may be inserted into the guide grooves 133 without interference with the knob 137. Thus, the slide cover 123 may be easily mounted on the frame 121 (see FIG. 3D and FIG. 4).

Note that, as shown in FIG. 7A to FIG. 7C, the back surface side rail portion 131a of the guide rail portion 131 having no rail-absent region 135 is formed so that a portion facing the rail-absent region 135 is thicker than a portion that does not face the rail-absent region 135, and has a guide surface 133a that is inclined toward the guide groove 133. Therefore, it is possible to easily insert the slide portions 123a and 123b of the slide cover 123 into the guide grooves 133.

In addition, resin springs 139 (see FIG. 2) are respectively provided for both slide portions 123a and 123b of the slide cover 123 near one end portion that is the insertion side of the slide cover 123. The resin springs 139 elastically contact the groove bottom surfaces of the guide grooves 133. By so doing, a predetermined slide load is imparted to opening or closing of the slide cover 123.

As described above, in the mirror unit 120 according to the present embodiment, a structure having no guide groove 133, that is, the rail-absent region 135 in which the back surface side rail portion 131a is not formed, is set in a predetermined region of the mounting frame portion 122 adjacent to the cover insertion side. Then, the slide cover 123 is arranged at the one end portions of the guide grooves 133 using the rail-absent region 135, and the slide cover 123 is slid in the longitudinal direction while being guided by the guide rail portions 131. By so doing, the slide cover 123 may be mounted on the frame 121 without interference of the knob 137 with the first vertical frame portion 121b1. That is, according to the present embodiment, the slide cover 123 may be easily mounted on the frame 121 without deforming the frame 121 to be expanded. Therefore, a slide load of the mounted slide cover 123 is stabilized, and a rattle of the slide cover 123 may be suppressed.

Note that, after the slide cover 123 is mounted, the mirror 125 is fitted into the open space 127 from the back surface side of the frame 121 so as to overlap the back surface side rail portions 131a of the mounting frame portions 122. That is, the mirror 125 is arranged in the open space 127 on the back surface side of the slide cover 123 (see FIG. 8A and FIG. 8B). Both mounting frame portions 122 each have a plurality of elastically deformable engaging pawls 141 on the facing inner side surfaces (see FIG. 2 and FIG. 5). The engaging pawls 141 engage with the back surfaces of both side edge portions of the mirror 125 arranged in the open space 127 to hold the mirror 125. In addition, mirror-holding resin springs 143 (see FIG. 2 and FIG. 5) are respectively provided at substantially the center portions of the mounting frame portions 122 in the slide direction. The resin springs 143 elastically contact the side end surfaces of the mirror 125 arranged in the open space 127. The mirror-holding resin springs 143 restrict a rattle of the mirror 135.

The thus configured mirror unit 120 is arranged in the mirror unit accommodating recess 111 of the sun visor body 103. In the present embodiment, as shown in FIG. 8A and FIG. 8B, a plurality of outward ribs 145 having a predetermined height are formed on the outer peripheral surface of the frame 121 of the mirror unit 120, and the ribs 145 prevent a skin material 104 that wraps the outer surface (surface) of the sun visor body 103 from slipping off from the mirror unit accommodating recess 111. When the mirror unit 120 is fitted into the mirror unit accommodating recess 111 while pressing the skin material 104 with the frame 121 of the mirror unit 120, the skin material 104 is held by the ribs 145 and the wall portion 147 of the mirror unit accommodating recess 111. In this way, the plurality of portions of the skin material 104 in the circumferential direction are partially held by the ribs 145 and the wall portion 147 to make it hard for the skin material 104 to move, thus effectively preventing the skin material 104 from slipping off from the mirror unit accommodating recess 111.

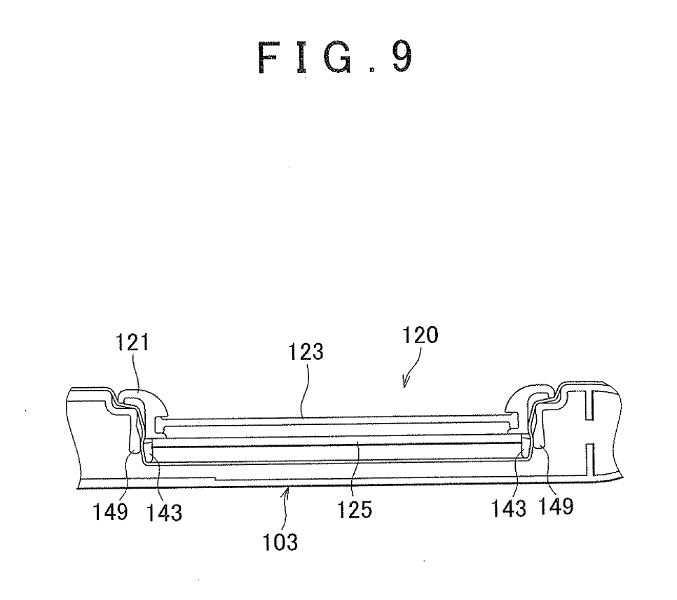

In addition, in the present embodiment, as shown in FIG. 9, resin springs 149 are further provided for the wall portion 147 of the mirror unit accommodating recess 111 of the sun visor body 103 in regions that face the mirror-holding resin springs 143 of the mounting frame portions 122. The resin springs 149 are set so as to elastically press the mirror-holding resin springs 143 toward the end surfaces of the mirror 125 to assist the holding force of the mirror-holding resin springs 143. By so doing, it is possible to further improve the mirror holding effect of the mirror-holding resin springs 143 formed on the mounting frame portions 122.

Note that, in the present embodiment, the rail-absent region 135 is formed only on one of the mounting frame portions 122; instead, the rail-absent region 135 may be further formed on the other one of the mounting frame portions 122. With the above configuration, when the insertion-side end portion of the slide cover 123 is placed in the rail-absent region 135 while the slide cover 123 is oriented parallel to the frame 121, the knob 137 is arranged in the open space 127 of the frame 121. Thus, when the slide cover 123 is slid toward the opposite side in this state, the slide portions 123a and 123b of the slide cover 123 may be inserted and mounted in the guide grooves 133 without interference of the knob 137 with the first vertical frame portion 121b1.

What is claimed is:

1. A mirror unit that is mounted on a sun visor body, comprising:
a frame that is fixed to the sun visor body;
a mirror that is mounted on the frame;
a cover that is mounted on the frame and that covers the mirror;
two facing wall portions that are formed on the frame and that extend along the frame; and
guide members that are respectively formed on both wall portions, that protrude in a direction in which both wall portions face each other and that allow the cover to slide along the wall portions, wherein
one end of each of the guide members is open, and
a guide member-absent region in which the guide member is partially not formed is provided at an end portion of at least one of both wall portions, the end portion of the wall portion being adjacent to the one end of the guide member.

2. The mirror unit according to claim 1, wherein
in the guide member-absent region, the cover is placed at the end portions of the wall portions along a direction perpendicular to a plane formed by the frame, and the guide members allow the cover to slide into a space surrounded by the frame to be accommodated while guiding the cover.

3. The mirror unit according to claim 1, wherein
a guide member-present region in which the guide member is formed is provided at the end portion of one of both wall portions, and the guide member-absent region is provided at the end portion of the other one of both wall portions.

4. The mirror unit according to claim 1, wherein
the guide member of one of both wall portions is shorter than the guide member of the other one of both wall portions.

5. The mirror unit according to claim 1, wherein
the frame has horizontal frame portions that are respectively provided with the wall portions and first and second vertical frame portions that connect respective end portions of the horizontal frame portions, and
in a state where the cover is arranged on both wall portions, a distance between the cover and the first vertical frame portion is equal to or longer than a distance between the cover and surfaces of the guide members, on which the cover is arranged.

6. The mirror unit according to claim 1, wherein
the cover has a manual operating portion that protrudes perpendicularly to the cover, and
when the cover is mounted, the manual operating portion is arranged in a space surrounded by the frame so that the manual operating portion does not interfere with mounting of the cover.

7. The mirror unit according to claim 1, wherein
each of the guide members is formed of a guide groove having a substantially U-shaped cross section.

8. The mirror unit according to claim 7, wherein
the guide members respectively have inclined guide surfaces that guide insertion of the cover into the guide grooves.

9. A vehicle sun visor comprising:
the mirror unit according to claim 1; and
a sun visor body that has an accommodating portion for accommodating the mirror unit.
